(19) United States
(12) Patent Application Publication
(10) Pub. No.: US 2021/0010304 A1
(43) Pub. Date: Jan. 14, 2021

(54) MOTOR VEHICLE LOCK

(71) Applicant: Brose Schließsysteme GmbH & Co. Kommanditgesellschaft, Wuppertal, Wuppertal (DE)

(72) Inventor: David ROSALES, Rochester Hills, MI (US)

(21) Appl. No.: 16/508,493

(22) Filed: Jul. 11, 2019

(51) Int. Cl. E05B 81/20; E05B 79/20

(52) U.S. Cl. CPC E05B 81/20; E05B 79/20

(57) ABSTRACT

A motor vehicle lock including a detent mechanism with a catch and a pawl. The motor vehicle lock may include a drive train arrangement with a drive element. The catch may be pivoted between an open position, a primary closed position and a secondary closed position, disposed between the open position and the primary closed position. When the pawl is in an engaged state, it blocks the catch in the primary closed position and in the secondary closed position and may be raised into a release state to release the catch. A predefined drive direction is assigned to the drive element and during a cinching sequence, by driving the drive element in the predefined drive direction, the drive train arrangement may engage and drive the catch in the closing direction into its primary closed position, or into an overtravel position beyond the primary closed position.

### TECHNICAL FIELD

The present disclosure relates to a motor vehicle lock and a motor vehicle lock arrangement including a motorized drive.

### BACKGROUND

Motor vehicles may include a motor vehicle lock for any kind of closure element of a motor vehicle, such as a liftgate, a trunk lid, rear hatch, rear door, front hood, side door, or the like. The closure elements may be pivotable or slidable. Certain closures may close and open automatically, e.g. without the assistance of an operator. Vehicles generally include a seal or other type of weather proofing barrier positioned between the closure and the vehicle body to mitigate external elements such as moisture, precipitation, dirt, debris, and noise from entering the interior of the vehicle. The force applied to the closure, by a latch for example, must be sufficient to overcome pressure associated with the closure and the seal to provide a cinching function. Also, the vehicle may be equipped with a device or mechanism that may automatically release the latch, so the closure may move to an open position.

### SUMMARY

One or more objects of the present disclosure may be to provide a motor vehicle lock with a cinching function and an opening function, that has a simple overall structure.

According to one or more embodiments, the motor vehicle lock may include a detent mechanism including a catch and a pawl. The motor vehicle lock may also include a drivetrain arrangement provided with a drive element, that may be driven in order to perform the opening function and the cinching function. The motor vehicle lock may be configured to operate in a cinching sequence, which realizes the cinching function, and a release sequence, which realizes the opening function. In the cinching sequence, the catch may be driven into its primary closed position, while in the release sequence, the pawl may be driven into its release state.

Both above noted functions may be realized by driving the single drive element in one and the same, predefined drive direction.

As one example, a drive element may be used, in particular a drive movement of the drive element in the predefined drive direction, to bring the drivetrain arrangement into a decoupling state, when the catch is to be driven into its primary closed position in the course of the cinching sequence.

In detail, it is proposed that the drivetrain arrangement may include a first coupling element with a first coupling surface and a second coupling element with a second coupling surface, that during the release sequence, the first coupling surface and the second coupling surface are in driving engagement with each other, transferring drive movements from the drive element to the pawl and that during the cinching sequence, by driving the drive element in the predefined drive direction, the drivetrain arrangement enters a decoupling state, in which the first coupling surface and the second coupling surface are out of driving engagement from each other.

With one or more of the proposed solution, the opening function as well as the cinching function may be realized with one and the same drive element, which is only to be driven in one and the same, predefined drive direction. This means, that the drive element may well be driven via a drive cable such as a bowden cable. This also means that the drive motor, that provides the motorized movement of the drive element, does only need to provide the drive motion in one single direction. This leads to a cost effective and an especially compact mechanical arrangement. Also in view of electrical control, the proposed solution is particularly simple, as the motorized movements have to be generated only in one single direction by the respective motorized drive.

The expression “decoupling state” is to be understood in a broad sense. This means, that for the decoupling state it is only necessary that the first coupling surface and the second coupling surface are out of driving engagement from each other. Accordingly, the way of interaction between the two coupling elements is varied during the cinching sequence, such that the drive element may drive the catch into its primary closed state without preventing the pawl from moving into its engaged state.

The pawl may be raised during the cinching sequence. This may be advantageous in view of an emergency situation during the cinching sequence. Releasing the catch in such an emergency situation during at least part of the cinching sequence is not hindered by the pawl, as the pawl is being raised as noted above.

The pawl may be free to move into an engaged state during the cinching sequence, when the catch reaches a primary closed position or an overtravel position.

In one or more embodiments, the cinching sequence may go back on a cinching drive movement of the drive element and the release sequence may go back on a release drive movement of the drive element. The cinching drive movement may include the release drive movement, such that the cinching sequence always goes along with a release sequence, which may lead to the above noted advantage regarding an emergency during the cinching sequence.

As one example the drive element may be coupled to the catch on the one hand and to the pawl on the other hand via two drivetrains, which are at least partly different from each other. This may allow to realize the motor vehicle lock with a simple construction.

As another example, the catch drivetrain, namely the drivetrain between the drive element and the catch, comprising a catch engagement lever.

According to one or more embodiments, the pawl may be assigned a pawl engagement lever, which pawl engagement lever is part of the pawl drivetrain.

According to another embodiment, the catch engagement lever and the pawl engagement lever may each provide one of the coupling elements, which may allow for a particular compact mechanical construction.

An offset of the pivot axis of the drive element on the one hand and the catch engagement lever on the other hand may provide particularly simple solutions to realize the decoupling state of the drivetrain arrangement.

The motorized drive may be coupled to the drive element of the drivetrain arrangement of the motor vehicle lock in order to provide a motorized cinching sequence and a motorized release sequence as noted above. All explanations given with respect to the first teaching are fully applicable to this second teaching.

In yet another embodiment, the motorized drive may be arranged separately from the motor vehicle lock, which allows a modular arrangement of the motor vehicle lock arrangement. However, it may be pointed out, that the motorized drive may well be integrated into the motor vehicle lock, which provides a very compact arrangement.

### BRIEF DESCRIPTION OF THE DRAWINGS

In the following, an embodiment of the invention is explained with respect to the drawings. In the drawings show

FIG. 1 a motor vehicle with a proposed motor vehicle lock,

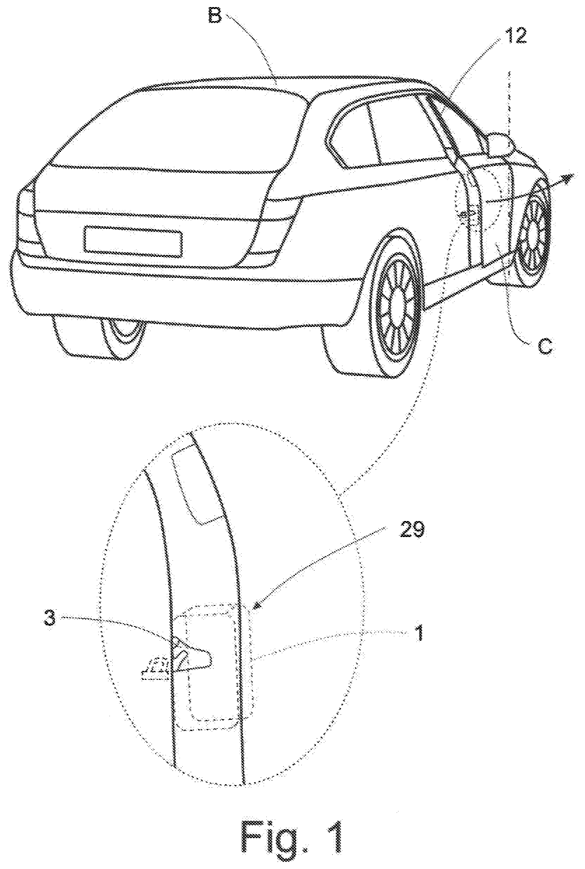

FIG. 2 the motor vehicle lock according to FIG. 1 with the catch in the open position,

FIG. 3 the motor vehicle lock according to FIG. 1 with the catch in the secondary closed position,

FIG. 4 the motor vehicle lock according to FIG. 1 with the catch in the primary closed position,

FIG. 5 the motor vehicle lock according to FIG. 1 at the end of the release sequence,

FIG. 6 the motor vehicle lock according to FIG. 1 during the cinching sequence,

FIG. 7 the motor vehicle lock according to FIG. 1 at the end of the cinching sequence.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

A known motor vehicle lock is provided in U.S. Pat. No. 6,471,259 B1. The motor vehicle lock may include a detent mechanism with a catch and a pawl, which interact with each other in order to hold the closing element in its respective closed position. For this, the catch may be pivoted between an open position, a primary closed position and a secondary closed position. For the opening function, a motorized opening drive is provided. For the cinching function, a motorized cinching drive is provided. Although in case of an emergency, the cinching drive is used for the cinching-function as well as for the opening-function, the opening drive is necessary in any case for moving the cinching-drive out of the path of movement of the catch.

The proposed motor vehicle lock 1 may be assigned to any kind of closing element of a motor vehicle. Such a closing element of a motor vehicle may be a liftgate, a trunk lid, a back door, a front hood, a side door or the like, as noted in the introductory part of the specification.

The motor vehicle lock 1 may include a detent mechanism 2 with a catch 3 and a pawl 4, which interact with each other in the usual way, as will be explained.

The motor vehicle lock 1 may include a drivetrain arrangement 5 with a drive element 6. The drivetrain arrangement 5 is designed to transmit drive movements from the drive element 6 to the detent mechanism 2. For this, motorized drive movements may be introduced into the drive element 6, as will be explained as well.

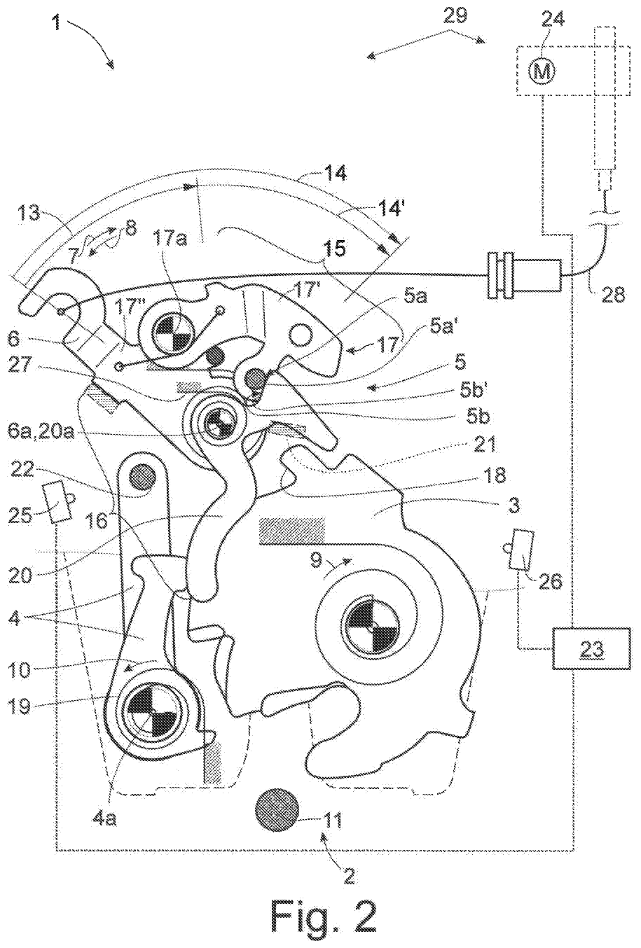

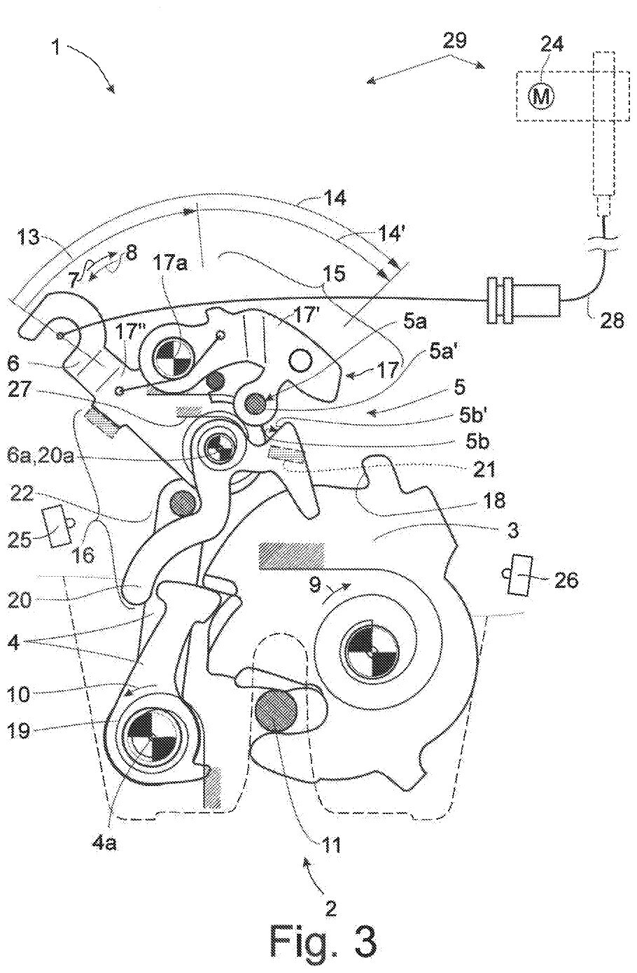

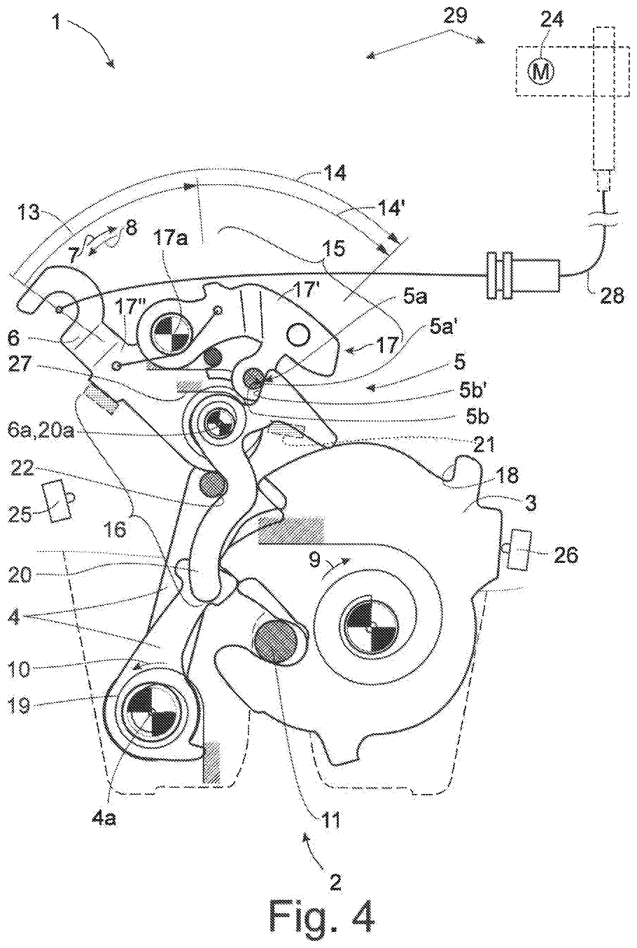

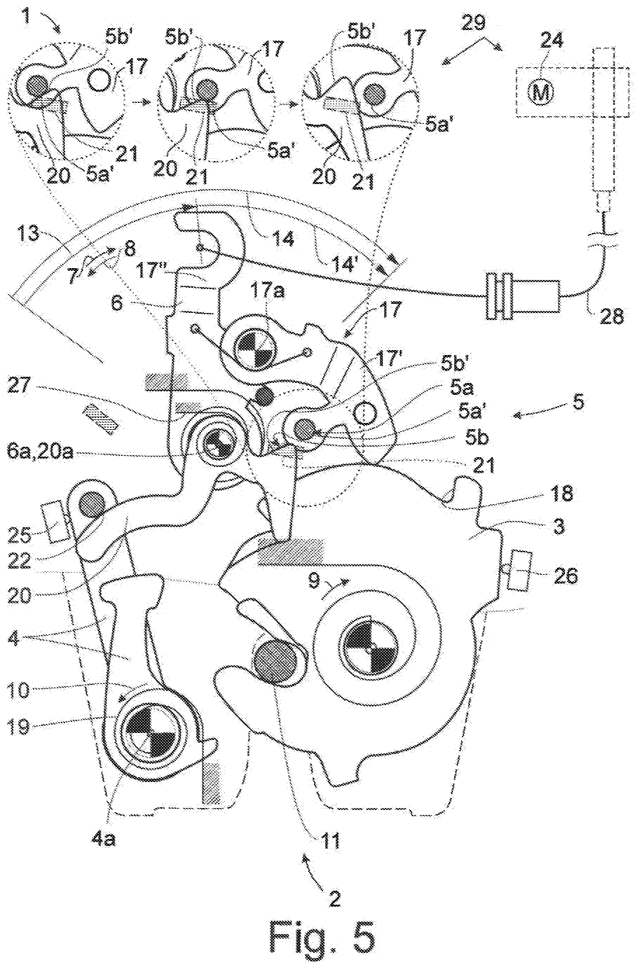

The catch 3 may be pivoted around a catch axis 3a between an open position (FIG. 2), a primary closed position (FIG. 4) and a secondary closed position (FIG. 3), which secondary closed position is situated between the open position and the primary closed position. The pawl 4 may be brought into an engaged state, blocking the catch 3 in the primary closed position (FIG. 4) and in the secondary closed position (FIG. 3) and may be raised into a release state (FIG. 5) to release the catch 3. For this, the pawl 4 is pivotable around a pawl axis 4a.

It may be pointed out that the pawl 4 may be part of a pawl arrangement, which pawl arrangement may comprise two or more pawls, blocking each other for blocking the catch 3 in its respective closing position. The pawl 4 as such may also be designed as a two or more part component, as is shown in the drawings.

A predefined drive direction 7 is assigned to the drive element 6. In the drawings, this predefined drive direction 7 is the clockwise direction. The drive element 6 may also be moved in a reverse direction 8, which is opposite to the drive direction 7. The drive element 6 is pivotable around a drive element axis 6a.

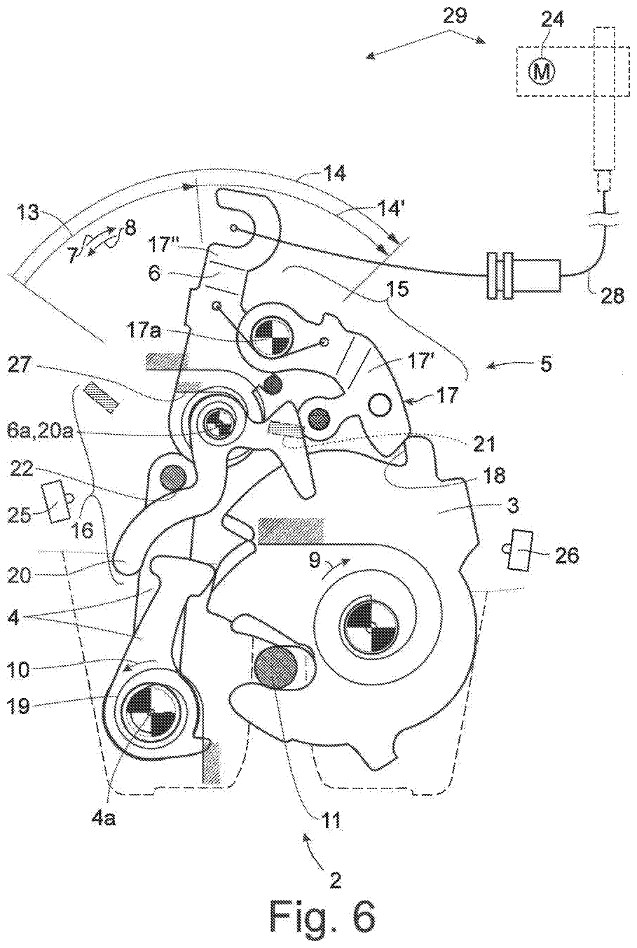

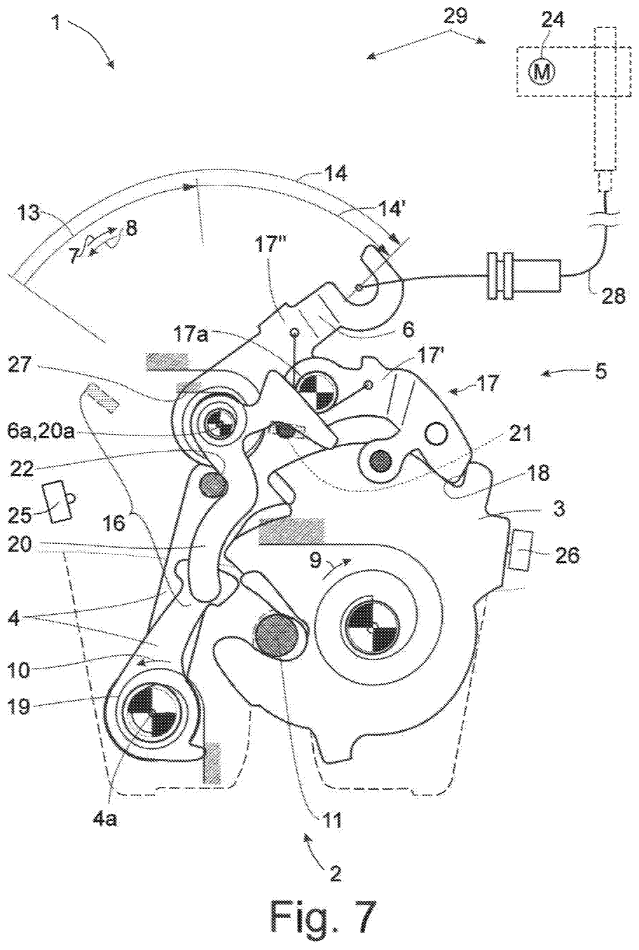

The sequence of FIG. 6 and FIG. 7 represents the cinching sequence, which is caused by driving the drive element 6 out of its initial position in the predefined drive direction 7. In the cinching sequence, the drivetrain arrangement 5 enters into engagement with the catch 3 and drives the catch 3 in its closing direction 9 into its primary closed position, such as into an overtravel position beyond the primary closed position as shown in FIG. 7. Here as an example, for the cinching sequence, the initial position of the catch 3 is the secondary closed position (FIG. 3), while the final position of the catch 3 is the primary closed position (FIG. 4).

The sequence of FIG. 4 and FIG. 5 represents the release sequence, which is caused by driving the drive element 6 out of its initial position in the predefined drive direction 7 as well. During the release sequence, the drivetrain arrangement 5 enters into engagement with the pawl 4 and drives the pawl 4 in its release direction 10 into its release state (FIG. 5).

During the cinching sequence, again by driving the drive element 6 in the predefined drive direction 7, the drivetrain arrangement 5 may enter a decoupling state (FIG. 6). For this, the drivetrain arrangement 5 may include a first coupling element 5a with a first coupling surface 5a′ and a second coupling element 5b with a second coupling surface 5b′. During the release sequence, the first coupling surface 5a′ and the second coupling surface 5b′ are in driving engagement with each other, transferring drive movements from the drive element 6 to the pawl 4, as may be extracted from the sequence of FIG. 4 and FIG. 5.

Furthermore, during the cinching sequence, by driving the drive element 6 in the predefined drive direction 7, the drivetrain arrangement 5 may enter a decoupling state, in which the first coupling surface 5a′ and the second coupling surface 5b′ are out of driving engagement from each other, as may be seen in FIG. 5. With the decoupling state of the drivetrain arrangement 5 being caused by driving the drive element 6 in the predefined drive direction 7, the cinching sequence as well as the release sequence may be realized by introducing motorized movements into the drive element 6 in only one drive direction, which makes the resulting mechanical construction particularly simple.

Just as a matter of completeness, it may be pointed out, that the catch 3 in its closed position is in holding engagement with a lock striker 11. Here as an example, the motor vehicle lock 1 is arranged at a closing element C, while the lock striker 11 is arranged at the body B of the motor vehicle. A vice versa arrangement is possible.

One interesting aspect of the shown embodiment is that during the cinching sequence, the pawl 4 is driven into its release state, before the catch 3 reaches the primary closed position or the overtravel position. With this it is guaranteed, that the pawl 4 does not hinder the movement of the catch 3 into the direction of its open position during an emergency situation.

As one example, during the cinching sequence, by driving the drive element 6 in the predefined drive direction 7, the drivetrain arrangement 5 enters into engagement with the catch 3 and moves the catch 3 in its closing direction, particularly into an overtravel position beyond the primary closed position, after the drivetrain arrangement 5 entered its decoupling state. With this it is guaranteed, that the pawl 4 may move into its engaged state during the cinching sequence, as shown in FIG. 7, without being hindered by the drive element 6.

The release sequence goes back on a release drive movement 13 of the drive element 6, while the cinching sequence goes back on a cinching drive movement 14 of the drive element 6. This is indicated in the drawings. Here it becomes apparent, that the cinching drive movement 14 includes the release drive movement 13, particularly, that the release drive movement 13 provides the start section of the cinching drive movement 14.

The drawings show, that the drivetrain arrangement 5 may include a catch drivetrain 15 between the drive element 6 and the catch 3 and a pawl drivetrain 16 between the drive element 6 and the pawl 4, wherein the catch drivetrain 15 and the pawl drivetrain 16 are at least partly different from each other. Here as an example, the two coupling elements 5a, 5b of the drivetrain arrangement 5 are part of the pawl drivetrain 16.

Various constructional embodiments for the realization of the proposed solution are possible. According to the embodiment shown in the drawings, the catch drivetrain 15 may include a catch engagement lever 17, which, during the cinching sequence, is driven to enter into engagement with an engagement surface 18 of the catch 3, thereby driving the catch 3 into its primary closed position and, here as an example, into the overtravel position beyond the primary closed position. The catch drivetrain 15 may include the drive element 6 as well as the catch engagement lever 17, which catch engagement lever 17 is pivotably coupled to the drive element 6 at a catch engagement lever axis 17a.

As noted above, when the drive element 6 is driven in its predefined drive direction 7 starting from the situation shown in FIG. 3, the catch engagement lever 17 enters into engagement with the engagement surface 18 of the catch 3 (FIG. 6), thereby driving the catch 3, here as an example, from the secondary closed position, into its primary closed position. In order to allow the pawl 4 to fall into its engagement state due to the force of the pawl spring 19, here and as another example, the catch engagement lever 17 drives the catch 3 into the overtravel position beyond the primary closed position. This is again shown in FIG. 7.

In one or more embodiments, the catch engagement lever 17 may include an output lever 17′, which, during the cinching sequence, enters into engagement with the engagement surface 18 of the catch 3 (FIG. 7). The catch engagement lever 17 may include an input lever 17″, that may be pivotable around the catch engagement lever axis 17a and which, together with the output lever 17′, establishes a knee lever mechanism. The result is a high cinching momentum at the catch 3 without the need for high driving forces. As one example, the catch engagement lever 17 may be a two piece component with a joint between the output lever 17′ and the input lever 17″, as noted above. The input lever 17″ may be provided by the drive element 6 itself.

The pawl drivetrain 16, here as one example, comprises a pawl engagement lever 20, which, during the release sequence, is driven to come into engagement with an engagement surface 22 of the pawl 4, driving the pawl 4 into its release state. The pawl engagement lever 20 is pivotable around a pawl engagement lever axis 20a, that may be arranged coaxially to the drive element axis 6a.

The coupling elements 5a, 5b may be provided by any drive component of the drivetrain arrangement 5. Here as one example, the catch engagement lever 17 provides the first coupling element 5a with the first coupling surface 5a′, while the pawl engagement lever 20 may provide the second coupling element 5b with the second coupling surface 5b′.

During the release sequence, which is represented by the sequence of FIG. 4 and FIG. 5, the coupling elements 5a, 5b are being moved relative to each other, such that the coupling surfaces 5a′, 5b′ come out of engagement from each other. This becomes apparent from the detail view in FIG. 5. In particular, a guiding contour 21 is provided, which guides the first coupling surface 5a′ out of engagement from the second coupling surface 5b′ during the cinching sequence, as may again be derived from the detail view in FIG. 5.

The drive element 6 is pivotable around the drive element axis 6a, while the catch engagement lever 17 is pivotable around the catch engagement lever axis 17a. The drive element axis 6a and the catch engagement lever axis 17a are offset from each other.

The release sequence represented by the sequence of FIG. 4 and FIG. 5 is working as follows: starting from the catch 3 being in its primary closed position (FIG. 4), the drive element 6 is being driven in its predefined drive direction 7, in FIG. 4 in the clockwise direction.

Driving the drive element 6 in its predefined direction 7 leads to the coupling surface 5a′ to come into engagement with the coupling surface 5b′, moving the pawl engagement lever 20 into engagement with an engagement surface 22 of the pawl 4. This results in a movement of the pawl 4 into its release state, as shown in FIG. 5.

Here it is to be noted, that the proposed solution is also interesting in terms of control technology. FIG. 2 shows, that an electric, in particular electronical, lock control 23 is provided for controlling the drive movements of the motorized drive 24, that produces the above noted drive movement of the drive element 6.

When the pawl 4 has reached its release state, a pawl sensor 25 is activated, leading to stopping the motorized drive 24 by the lock control 23. With the drivetrain between the drive element 6 and the motorized drive 24 being back driveable, the catch 3 with its engagement surface 18, driven by the seal 12 of the closing element C, back drives the catch engagement lever 17 and with it the drive element 6 into the direction of its initial position. The situation after completion of the release sequence is shown in FIG. 2.

The cinching sequence starts from the catch 3 resting in its secondary closed position shown in FIG. 3. Driving the drive element 6 in the predefined drive direction leads first of all to the drive element 6 passing the release drive movement 13, moving the pawl 4 into the release state as noted before. In the course of the cinching drive movement 14, especially in the course of the movement section 14′, here as one example after bringing the drive arrangement 5 into its decoupling state, the catch engagement lever 17 enters into engagement with the engagement surface 18 of the catch 3, driving the catch 3 into the direction of the primary closed position, here as one example into the overtravel position as shown in FIG. 7. When reaching the primary closed position and/or the overtravel position, a catch sensor 26 is activated, which causes the lock control 23 to stop the motorized drive 24. As a result, the drive element 6 is driven into its initial position mainly by its drive element spring 27.

In all embodiments, the motorized drive 24 may be provided, that may be coupled to the drive element 6 of the drivetrain arrangement 5 in order to provide a motorized cinching sequence and a motorized release sequence as noted above. Such motorized drive 24 is indicated in the drawings. The motorized drive 24 may be an integral part of the motor vehicle lock 1, leading to a compact overall arrangement. However, here as one example, the motorized drive 24 is realized and arranged separately from the motor vehicle lock 1. Further, the motorized drive 24 may be coupled to the drive element 6 via a drive cable, such as a bowden cable 28.

According to another teaching, a motor vehicle lock arrangement 29 is claimed as such, which may include an above noted motor vehicle lock 1 as well as an above noted motorized drive 24. In one or more embodiments, the motorized drive 24 may be coupled to the drive element 6 of the drivetrain arrangement 5 in order to provide a motorized cinching sequence and a motorized release sequence. All explanations given for the motor vehicle lock 1 and its interaction with the motorized drive 24 are fully applicable to this teaching.

The motorized drive 24 may be arranged separately from the motor vehicle lock 1 as noted above. Further, the coupling between the motorized drive 24 and the drive element 6 may include a drive cable such as the bowden cable 28, which is indicated in the drawings by just a solid line.

According to another teaching, the motorized drive 24 for a motor vehicle lock may be provided by a closing element drive (not shown), which serves for driving the closing element between an opened position and a closed position of the closing element. The closing element drive is coupled to the closing element on the one hand and to a drive cable, in particular a bowden cable, on the other hand. The closing element drive is assigned a mechanical linkage, which may be driven between a deployed state and a retracted state by the closing element drive, wherein the drive cable transmits a drive movement depending on its change in state.

A motor vehicle lock 1, such as a motor vehicle lock 1 described above, may be coupled to the drive cable. In the shown embodiment, the drive element 6 may be coupled to the drive cable, such that a cinching sequence and/or a release sequence may be initiated by the closing element drive. The motor vehicle lock 1 may be brought into an opening state, into a secondary closing state and into a primary closing state.

The closing element drive may include a drive motor, which may be driven in two drive directions, whereby the drive motor may be positioned into a number of drive positions.

In order to drive the motor vehicle lock 1 into its secondary closing state, in a first step, the drive motor is driven in its first drive direction into a first drive position, driving the closing element into a position, which corresponds to the secondary closing position of the motor vehicle lock 1. In a second step, the drive motor is again driven in its first drive direction into a second position, which leads to the mechanical linkage changing its state and thereby driving the motor vehicle lock 1 via the drive cable into its primary closed position. Finally, in a third step, the drive motor is driven in its second drive direction into a third drive position, which is arranged between the first drive position and the second drive position. Those three drive positions are stored in a motor controller and may be optimized during the operation of the proposed system. The drive positions may be represented by the respective number of rotations of a motor shaft or the like.

There are a number of advantageous constructional variants possible to realize the mechanical linkage. The linkage, for example, may comprise a sliding guide, being able to be slid between the above noted deployed and the above noted retracted state. The mechanical linkage may as well include a rotating cam, which rotation may lead to reaching the above noted deployed and the above noted retracted state.

It may finally be pointed out, that the above noted third teaching is not restricted to be used in connection with the above noted motor vehicle lock 1 according to the first teaching. It is rather universally applicable to all kinds of motor vehicle locks 1 that provide a cinching mechanism, which may be driven by a drive cable, like a bowden cable.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A motor vehicle lock comprising:
a detent mechanism provided with a catch and a pawl; and
a drive train arrangement provided with a drive element configured to move in a predefined drive direction,
wherein the catch is configured to be pivoted between an open position, a primary closed position, and a secondary closed position, wherein the secondary closed position is disposed between the open position and the primary closed position,
wherein when the pawl is in an engaged state, the pawl blocks the catch when the catch in the primary closed position and in the secondary closed position, wherein the pawl is configured to be raised into a release state to release the catch,
wherein during a cinching sequence, as the drive element drives in the predefined drive direction, the drive train arrangement moves to engage the catch and drives the catch in a closing direction to the primary closed position,
wherein during a release sequence, as the drive element drives in the predefined drive direction, the drive train arrangement moves to engage and drive the pawl a release direction to the release state,
wherein the drive train arrangement includes a first coupling element provided with a first coupling surface and a second coupling element provided with a second coupling surface,
wherein during the release sequence, the first coupling surface and the second coupling surface are in driving engagement with each other, to transfer drive movements from the drive element to the pawl,
wherein during the cinching sequence, as the drive element moves in the predefined drive direction, the drive train arrangement enters a decoupling state, wherein when the drivetrain arrangement is in the decoupling state, the first coupling surface and the second coupling surface are out of driving engagement from each other, such that the pawl may move into the engaged state independently from the drive element.

2. The motor vehicle lock of claim 1, wherein during the cinching sequence, the pawl is driven into the release state, before the catch reaches the primary closed position or an overtravel position.

3. The motor vehicle lock of claim 1, wherein during the cinching sequence, as the drive element is driven in the predefined drive direction, the drive train arrangement into engages and moves the catch to the closing direction to an overtravel position beyond the primary closed position, after the drive train arrangement enters the decoupling state.

4. The motor vehicle lock of claim 1, wherein when the catch is in the open position, the drive element is in a first position and when the catch is in the primary closed position, the drive element is in a second position, wherein during the release sequence, the drive element moves in the predefined drive direction to a third position, disposed between the first and second positions.

5. The motor vehicle lock of claim 1, wherein the drive train arrangement includes:
a catch drivetrain disposed between the drive element and the catch, and
a pawl drivetrain disposed between the drive element and the pawl wherein the catch drive train and the pawl drive train are at least partly different from each other.

6. The motor vehicle lock of claim 5, wherein the catch drivetrain includes a catch engagement lever wherein during the cinching sequence, the catch engagement lever is driven to engage an engagement surface of the catch to drive the catch to the primary closed position.

7. The motor vehicle lock of claim 6, wherein the catch engagement lever includes an output lever, wherein during the cinching sequence, the output lever moves to engage the engagement surface of the catch.

8. The motor vehicle lock of claim 7, wherein the pawl drivetrain includes a pawl engagement lever, wherein during the release sequence, the pawl engagement lever is driven to engage an engagement surface of the pawl the pawl to the release state.

9. The motor vehicle lock of claim of 8, wherein the catch engagement lever includes the first coupling element provided with the first coupling surface, wherein the pawl engagement lever includes the second coupling element provided with a second coupling surface.

10. The motor vehicle lock of claim 1, wherein during the cinching sequence, the first and second coupling elements move relative to each other such that the first and second coupling surfaces disengage each other.

11. The motor vehicle lock claim 1, wherein a guiding contour is provided, which guides the first coupling surface to disengage from the second coupling surface during the cinching sequence.

12. The motor vehicle lock of claim 1, further comprising:
a motorized drive coupled to the drive element of the drive train in order to provide a motorized cinching sequence and a motorized release sequence.

13. The motor vehicle lock of claim 12, further comprising a drive cable disposed between the motorized drive and the drive element.

14. The motor vehicle lock of claim 5, wherein the two coupling elements of the drive train arrangement are formed by the pawl drive train.

15. The motor vehicle lock of claim 7, wherein the catch engagement lever includes an input lever, wherein the input lever is pivotable about a catch engagement lever axis, and wherein the input lever and the output lever forms a knee lever mechanism.

16. A motor vehicle lock comprising:
a catch configured to be pivoted between an open position, a primary closed position, and a secondary closed position, wherein the secondary closed position is disposed between the open position and the primary closed position;
a pawl, wherein when the catch is in either the primary closed position or the secondary closed position, the pawl engages the catch;
drive element configured to rotate about a drive-element axis in a drive direction from a first position, a second position, and a third position; and
a catch engagement lever pivotally coupled to the drive element about a catch-engagement-lever axis, wherein during the cinching sequence, the drive element rotates about the drive-element axis in the drive direction from the first position to the second position so that the catch engagement lever rotates about the catch-engagement-lever axis in a first direction and translates towards the catch.

17. The motor vehicle lock of claim 16, wherein during the cinching sequence, the drive element rotates about the drive-element axis in the drive direction from the second position to the third position so that the catch engagement lever rotates in a second direction, opposite the first direction, and translates the catch engagement lever to rotate the catch to the primary closed position.

18. The motor vehicle lock of claim 17, further comprising a pawl engagement lever configured to rotate about a pawl-engagement-lever axis, wherein the pawl engagement lever engages the pawl when the catch is in the open position, wherein as the drive element rotates about the drive-element axis in the drive direction from the first position to the second position, the catch engagement lever engages the pawl engagement lever so that the pawl engagement lever rotates and disengages the pawl.

19. The motor vehicle lock of claim 18, wherein the pawl-engagement-lever axis and the drive-element axis are same.

20. A motor vehicle lock comprising:
a catch configured to be pivoted between an open position, a primary closed position, and a secondary closed position, wherein the secondary closed position is disposed between the open position and the primary closed position;
a pawl, wherein when the catch is in either the primary closed position or the secondary closed position, the pawl engages the catch; and
a knee lever mechanism including
a drive element configured to rotate about a drive-element axis in a drive direction from a first position, a second position, and a third position, and
a catch engagement lever pivotally coupled to the drive element about a catch-engagement-lever axis, wherein during the cinching sequence, the drive element rotates about the drive-element axis in the drive direction from the first position to the second position so that the catch engagement lever is driven towards the catch so that the catch moves from the secondary closed position to the primary closed position.
